(19) United States
(12) Patent Application Publication
(10) Pub. No.: US 2006/0073814 A1
(43) Pub. Date: Apr. 6, 2006

(54) Embedded specification of menu navigation for mobile devices

(75) Inventors: Timothy E. Allen, Durham, NC (US); Jennifer Newnam, Wake Forest, NC (US); Richard Redpath, Cary, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/959,820

(22) Filed: Oct. 5, 2004

(51) Int. Cl. H04Q 7/38; H04M 3/42

(52) U.S. Cl. 455/414.1; 379/201.01

(57) ABSTRACT

A method, system and apparatus for specifying menu navigation for mobile devices. In accordance with the present invention, a listing of resources in a mobile application each can be configured with a hyperlink specifying a computing location of the resource. Each hyperlink further can include an embedded specification of menu navigation data for the resource. The menu navigation data can include a specification of the type of menu to be constructed in the menu bar of a content browser in the mobile device when rendering the resource. The menu navigation data further can include a specification of the content of a context menu which can be activated when selecting portions of the resource when rendered in the mobile device. In either case, when selected, the hyperlink along with the menu navigation data can be provided to the content server which can serve the resource to the mobile device, and which further can configure the mobile device according to the menu navigation data.

### BACKGROUND OF THE INVENTION

1. Statement of the Technical Field

The present invention relates to the field of navigation in a software application and more particularly to specifying menu navigation in a mobile device.

2. Description of the Related Art

The conventional graphical user interface (GUI) has been widely used for many years. The primary function of the GUI includes providing user interface controls with which the end-user can interact with an underlying application. The common GUI includes many stock user interface controls, most of which, when combined, can accommodate most computer-human interactions required by an application. To that end, a menu bar control can provide a fixed, navigable textual menu for navigating the functionality of an application. By comparison, a context menu control can provide floating, navigable textual menu for the context sensitive navigation of the functionality of an application.

When user interface controls are displayed in a GUI, often one must compromise between the amount of information which can be displayed within the GUI display, and the amount of displayable space within the GUI display in which a preferred amount of information can be presented. Where the display area must be reduced due to height and width constraints, information that otherwise might be easily grouped and viewed in within a larger display space often cannot be presented as a single, cohesive set of interrelated interface controls. This circumstance has been known to arise in the use of pervasive devices, including handheld computers and portable cellular telephones. In the case of pervasive devices, the display area sometimes can be limited to as little as a 160 pixel by 160 pixel region or less.

Notably, rendering menu controls in a pervasive device can be particularly challenging. For instance, in many cases the client-side component of a distributed application can be markup language specified for rendering in a markup language browser. Yet, the menu bar control of the markup language browser is deemed fixed and immutable in content. Consequently, to the extent that a menu bar control forms a required control element of a user interface, the menu bar control can be emulated through markup language specified controls. Nevertheless, the rendering of an emulated menu control using markup language can consume an inordinate amount of valuable real estate in the user interface of the pervasive device.

Rendering a context menu control in the markup language browser of a pervasive device can be equally problematic. In that the context sensitivity of a context menu control requires some computing logic to determine the nature and content of the context menu control, conforming logic must be included in the markup language document distributed to the pervasive device. Yet, many markup language browsers for pervasive devices cannot support extensive markup language embedded logic. In addition, the use of embedded logic requires more bandwidth to transfer additional markup to the mobile device which will impact latency.

The problem of specifying navigation controls for mobile devices has become especially acute in reference to the use of pervasive device hosted clients when accessing collaborative computing applications. Specifically, so much of the user interface for a collaborative computing application can be context sensitive. For instance, the content of any one menu bar control or context menu can be depend largely on the identity of the end user, the type of collaborative resource at issue, and the nature of the collaborative content at issue. Consequently, it is not reasonable to expect logic aboard the pervasive device to support the variability of the user interface while respecting the limited nature of the display of the pervasive device.

### SUMMARY OF THE INVENTION

The present invention addresses the deficiencies of the art in respect to specifying menu navigation in a mobile device and provides a novel and non-obvious method, system and apparatus for the embedded specification of menu navigation for mobile devices. A method for specifying menu structure and content in a mobile device can include the steps of extracting menu navigation data from a link locator requesting the retrieval of a specified resource. The specified resource can be retrieved and the retrieved specified resource can be forwarded to a designated mobile device. Finally, at least one of a menu bar control and a context menu control can be configured in a host application in the designated mobile device according to the extracted menu navigation data.

A system for specifying menu structure and content in a mobile device can include a list of resources. The list can include one or more entries, each entry having an association with a link locator and menu navigation data. The menu navigation data can specify at least one of structure and content for at least one of a menu bar control and a context menu control. The system further can include event handling logic configured to respond to the activation of an entry in the list by embedding a link locator and menu navigation data for the entry in a request to retrieve a resource associated with the entry. In a particular aspect of the invention, the list of resources can include individual team rooms in a collaborative space. Moreover, the link locator can be a uniform resource locator.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system, method and apparatus for the embedded specification of menu navigation for mobile devices; and,

FIG. 2 is a flow chart illustrating a process for managing the embedded specification of menu navigation for mobile devices.

### DETAILED DESCRIPTION OF THE PREFERRED EMBODIMENTS

The present invention is a method, system and apparatus for specifying navigation for mobile devices. In accordance with the present invention, a listing of resources in a mobile application each can be configured with a hyperlink specifying a computing location of the resource. Each hyperlink further can include an embedded specification of navigation data for the resource. The navigation data can include a specification of the type of menu to be constructed in the menu bar of a content browser in the mobile device when rendering the resource. The menu navigation data further can include a specification of the content of a context menu which can be activated when selecting portions of the resource when rendered in the mobile device. In either case, when selected, the hyperlink along with the menu navigation data can be provided to the content server which can serve the resource to the mobile device, and which further can configure the mobile device according to the menu navigation data.

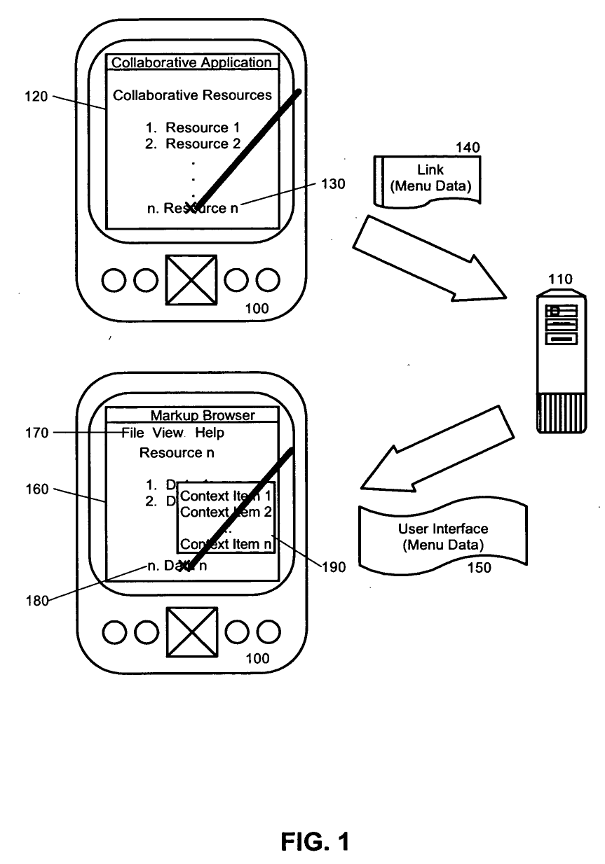

In further illustration, FIG. 1 is a schematic illustration of a system, method and apparatus for the embedded specification of menu navigation for mobile devices. As shown in FIG. 1, a mobile device 100 can host an application which can include an interactive user interface 120. The interactive user interface 120 can render content provided by a content server 110 over a computer communications network. In this regard, the content can be either wholly or partially provided by the content server 110 which content can include a listing of accessible resources 130. In a particular aspect of the invention, the application can be a collaborative application and the accessible resources 130 can refer to individual team rooms of a collaborative space.

Each entry in the listing of the accessible resources 130 can include an associated hyperlink 140 to a corresponding resource which can be provided by or with the assistance of the content server 110 or other content servers (not shown). Preferably, the corresponding resource can be a markup language defined resource such as a Web page or an extensible markup language (XML) defined document, although the invention is not limited strictly to a markup language defined resource. Rather, other types of content can equally suffice which content can include audio and visual content such as bitmapped graphics or remotely accessible media. Other types of content also can include references to remotely provided application logic, just to name a few examples.

Importantly, menu navigation data can be embedded or encoded in the hyperlink 140. In this regard, the menu navigation data can specify the content or structure of a menu bar control. Examples of menu content can include a specification of menu entries, sub-menus, and sub-menu entries. The menu structure, of course, can include the ordering of menu entries in a menu/sub-menu hierarchy. As an example, a hyperlink containing embedded menu navigation data for a menu bar control can include, “http://myportal.com/resource1?menubar=#new#view#tools”.

Notably, the menu navigation data further can specify the content and structure of a context menu control. As an example, a hyperlink containing embedded menu navigation data for a context menu control can include, “http://myportal.com/resource1?context=#file”. Unlike a menu bar control, however, in a mobile device a context menu control can be activated in response to a particular user interface event such as a “tap-and-hold” operation as is well known in the art. Consequently, the content and structure of a context menu control can be configured specifically according to the context in which the context menu has been activated.

When an entry in the listing of accessible resources 130 has been selected, the hyperlink 140 associated with the entry can be provided to the content server 110 specified by the hyperlink 140 in the form of a request. The content server 110 can parse the hyperlink 140 to extract the menu navigation data. Utilizing the extracted menu navigation data, a user interface 150 for the selected resource can be constructed which further specifies one or both of the content and structure of a menu bar control and a context menu control.

Specifically, the user interface 150 for the requested resource can be rendered in a content browser 160 in the mobile device 100. The menu navigation data can specify the content and structure for the menu bar control 170 of the content browser 160, as well as the content and structure for a context menu control 190 which can be activated through a tap-and-hold operation for a portion 180 of the user interface 150. For instance, the content browser 160 can include an application programming interface enabling the configuration of the content and structure of the menu bar control 170 and the context menu control 190. As such, the content and structure of the context menu control 190 can be configured without requiring complex scripting logic in the content itself. Moreover, by virtue of the dynamically specified menu navigation data, the menu bar control 170 can be configured even though the menu bar control can be part of the browser 160 and not the user interface 150.

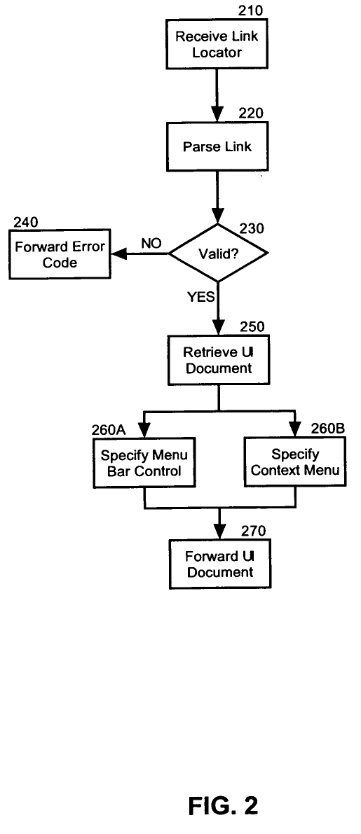

In more particular illustration of a specific albeit non-exclusive aspect of the present invention, FIG. 2 is a flow chart illustrating a process for managing the embedded specification of menu navigation for mobile devices. Beginning in block 210 a link locator can be received for processing. The link locator can specify a location of a requested resource and preferably can be a uniform resource locator (URL). Subsequently, in block 220 the link locator can be parsed to determine whether the link locator has been validly specified and to extract embedded menu navigation data.

In decision block 230, it can be determined whether the link locator has been validly specified. In this regard, a valid link locator can specify a network location for a desired resource such as a markup language document. Moreover, a valid link locator can include syntactically proper menu navigation data. If the link locator does not validly specify a location of a resource, in block 240 an error code can be returned to the sender of the link locator. Otherwise, in block 250 the requested resource can be obtained. For instance, where the resource is a markup language document, the document can be retrieved from a specified network location.

In addition to obtaining the requested resource, in block 260A, the structure and content of a menu bar control can be extracted from the link locator. Moreover, in block 260B, the structure and content of a context menu control can be extracted from the link locator. In particular, the information extracted from the link locator can fully specify a menu and its sub-menus. Based upon the extracted specification for the menu bar control and the context menu control, the requested resource can be modified to direct the content and structure of one or both of a menu bar control and context menu for a host application in a mobile device associated with the sender. Consequently, in block 270 the modified resource can be forwarded to the sender.

The present invention can be realized in hardware, software, or a combination of hardware and software, including a proxy which can preprocess menu data requests. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for specifying menu structure and content in a mobile device, the method comprising the steps of:
extracting navigation data from a link locator requesting the retrieval of a specified resource;
retrieving said specified resource and forwarding said retrieved specified resource to a designated mobile device; and,
configuring at least one of a menu bar control and a context menu control in a host application in said designated mobile device according to said extracted navigation data.

2. The method of claim 1, further comprising the step of receiving said link locator as part of a resource request from said designated mobile device.

3. The method of claim 1, wherein said forwarding step comprises the step of forwarding said retrieved specified resource to said designated mobile device as part of a resource response to said resource request.

4. The method of claim 2, further comprising the steps of:
associating navigation data with corresponding entries in a list of resources in said mobile device; and,
responsive the selection of an entry in said list, embedding corresponding associated navigation data in a resource request for said entry and forwarding said resource request to a content server.

5. A system for specifying menu structure and content in a mobile device, the system comprising:
a list of resources, said list comprising a plurality of entries, each of said entries comprising an association with a link locator and menu navigation data; and,
event handling logic configured to respond to the activation of an entry in said list by embedding a link locator and menu navigation data for said entry in a request to retrieve a resource associated with said entry.

6. The system of claim 5, wherein said list of resources comprises individual team rooms in a collaborative space.

7. The system of claim 5, wherein said link locator is a uniform resource locator.

8. The system of claim 5, wherein said menu navigation data specifies at least one of structure and content for at least one of a menu bar control and a context menu control.

9. The system of claim 5, further comprising a content browser configured to render said resources, said content browser comprising at least one of a configurable menu bar control and a context menu control, said content browser further comprising an application programming interface programmed to permit the configuration of said menu bar control and said context menu control.

10. A machine readable storage having stored thereon a computer program for specifying menu structure and content in a mobile device, the computer program comprising a routine set of instructions which when executed by a machine cause the machine to perform the steps of:
extracting menu navigation data from a link locator requesting the retrieval of a specified resource;
retrieving said specified resource and forwarding said retrieved specified resource to a designated mobile device; and,
configuring at least one of a menu bar control and a context menu control in a host application in said designated mobile device according to said extracted menu navigation data.

11. The machine readable storage of claim 10, further comprising additional instructions for causing the machine to additionally perform the step of receiving said link locator as part of a resource request from said designated mobile device.

12. The machine readable storage of claim 10, wherein said forwarding step comprises the step of forwarding said retrieved specified resource to said designated mobile device as part of a resource response to said resource request.

13. The machine readable storage of claim 11, further comprising additional instructions for causing the machine to additionally perform the steps of:
associating menu navigation data with corresponding entries in a list of resources in said mobile device; and,
responsive the selection of an entry in said list, embedding corresponding associated menu navigation data in a resource request for said entry and forwarding said resource request to a content server.
